(19) United States
(12) Patent Application Publication
(10) Pub. No.: US 2016/0065453 A1
(43) Pub. Date: Mar. 3, 2016

(54) COOPERATIVELY MANAGING ROLE BASED QUALITY OF SERVICE

(71) Applicant: International Business Machines Corporation, Armonk, NY (US)

(72) Inventors: Kulvir S. Bhogal, Fort Worth, TX (US); Gregory J. Boss, Saginaw, MI (US); David B. Lection, Raleigh, NC (US); Anne R. Sand, Canon City, CO (US)

(21) Appl. No.: 14/468,369

(22) Filed: Aug. 26, 2014

(51) Int. Cl. H04L 12/725; H04L 12/825

(52) U.S. Cl. CPC H04L 45/302; H04L 47/25

(57) ABSTRACT

According to one exemplary embodiment, a method for managing a quality of service level associated with an active communications channel is provided. The method may include receiving an indication of network degradation corresponding with a degradation event from a router, wherein the degradation event is associated with the active communications channel. The method may include requesting an identifier corresponding with a user operating a user device, wherein the user device is associated with the active communications channel. The method may include prompting the user operating the user device to select the quality of service level. The method may include receiving a user selected quality of service level and the identifier corresponding with the user, wherein the user selected quality of service level is associated with the identifier. The method may include configuring the quality of service level to match the user selected quality of service level.

### BACKGROUND

The present invention relates generally to the field of computing, and more particularly to managing quality of service.

Network routers often control the quality of service level associated with the data being directed by the routers through active communications channels to connect electronic devices. Quality of service levels may include, among other things, considerations for the probability of dropped packets, bit rate and delay. Due to the finite resources of routers to provide quality of service, routers may not be able to provide optimal quality of service to every electronic device connected to the routers.

### SUMMARY

According to one exemplary embodiment, a method for managing a quality of service level within a plurality of quality of service levels associated with an active communications channel is provided. The method may include receiving an indication of network degradation corresponding with a degradation event from a router, wherein the degradation event is associated with the active communications channel. The method may also include requesting an identifier corresponding with a user operating a user device, wherein the user device is associated with the active communications channel. The method may then include prompting the user operating the user device to select the quality of service level within the plurality of quality of service levels associated with the active communications channel. The method may further include receiving a user selected quality of service level and the identifier corresponding with the user, wherein the user selected quality of service level is associated with the identifier corresponding with the user. The method may also include configuring the quality of service level associated with the active communications channel to match the user selected quality of service level.

According to another exemplary embodiment, a computer system for managing a quality of service level within a plurality of quality of service levels associated with an active communications channel is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving an indication of network degradation corresponding with a degradation event from a router, wherein the degradation event is associated with the active communications channel. The method may also include requesting an identifier corresponding with a user operating a user device, wherein the user device is associated with the active communications channel. The method may then include prompting the user operating the user device to select the quality of service level within the plurality of quality of service levels associated with the active communications channel. The method may further include receiving a user selected quality of service level and the identifier corresponding with the user, wherein the user selected quality of service level is associated with the identifier corresponding with the user. The method may also include configuring the quality of service level associated with the active communications channel to match the user selected quality of service level.

According to yet another exemplary embodiment, a computer program product for managing a quality of service level within a plurality of quality of service levels associated with an active communications channel is provided. The computer program product may include one or more computer-readable storage devices and program instructions stored on at least one of the one or more tangible storage devices, the program instructions executable by a processor. The computer program product may include program instructions to receive an indication of network degradation corresponding with a degradation event from a router, wherein the degradation event is associated with the active communications channel. The computer program product may also include program instructions to request an identifier corresponding with a user operating a user device, wherein the user device is associated with the active communications channel. The computer program product may then include program instructions to prompt the user operating the user device to select the quality of service level within the plurality of quality of service levels associated with the active communications channel. The computer program product may further include program instructions to receive a user selected quality of service level and the identifier corresponding with the user, wherein the user selected quality of service level is associated with the identifier corresponding with the user. The computer program product may then include program instructions to configure the quality of service level associated with the active communications channel to match the user selected quality of service level.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flow chart illustrating a process for cooperatively managing quality of service according to at least one embodiment; and

FIG. 3 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for cooperatively managing role based quality of service.

As described above, network routers may control the quality of service level of data delivered to electronic devices connected to the routers. With finite resources available to routers to deliver quality of service levels, quality of service levels may be prioritized among the individual electronic devices connected to the router whereby some electronic devices may receive lower quality of service in order to maintain high quality of service levels for other electronic devices. Determining what electronic devices will receive high quality of service levels for network traffic passing through a router may be implemented through automatic algorithms. However, such algorithms may assign more resources to some connected electronic devices than required at the detriment of other electronic devices that need more router resources. Therefore, it may be advantageous to, among other things, provide a method to prompt a user to specify the quality of service level desired for electronic devices that are connected to the router.

The present embodiment provides a method to detect degraded network performance associated with an active communications channel at a router. Additionally the present embodiment may provide a mechanism to request, for example, an application or operating system, to prompt a user experiencing degraded network performance to obtain an enhanced quality of service level. Furthermore, the present invention may prompt a user for payment information or other means to authorize the user to receive enhanced network performance through higher quality of service. After the user responds to the prompt, the user selected quality of service level may be used to reconfigure the router and downstream internet connections to match the user selected quality of service level.

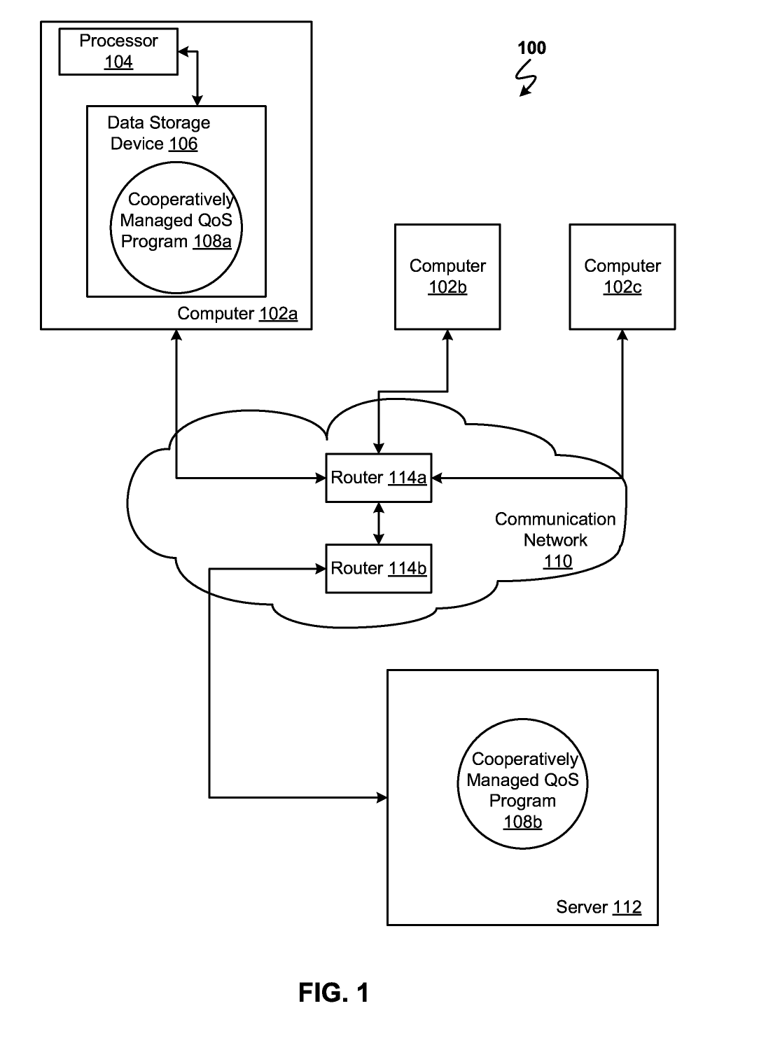

Referring now to FIG. 1, an exemplary networked computer environment 100 in accordance with one embodiment is depicted. The networked computer environment 100 may include a computer 102a with a processor 104 and a data storage device 106 that is enabled to run a cooperatively managed quality of service (QoS) program 108a. The networked computer environment 100 may also include a server 112 that is enabled to run a cooperatively managed QoS program 108b and a communication network 110. The networked computer environment 100 may include a plurality of computers 102a-c and servers 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

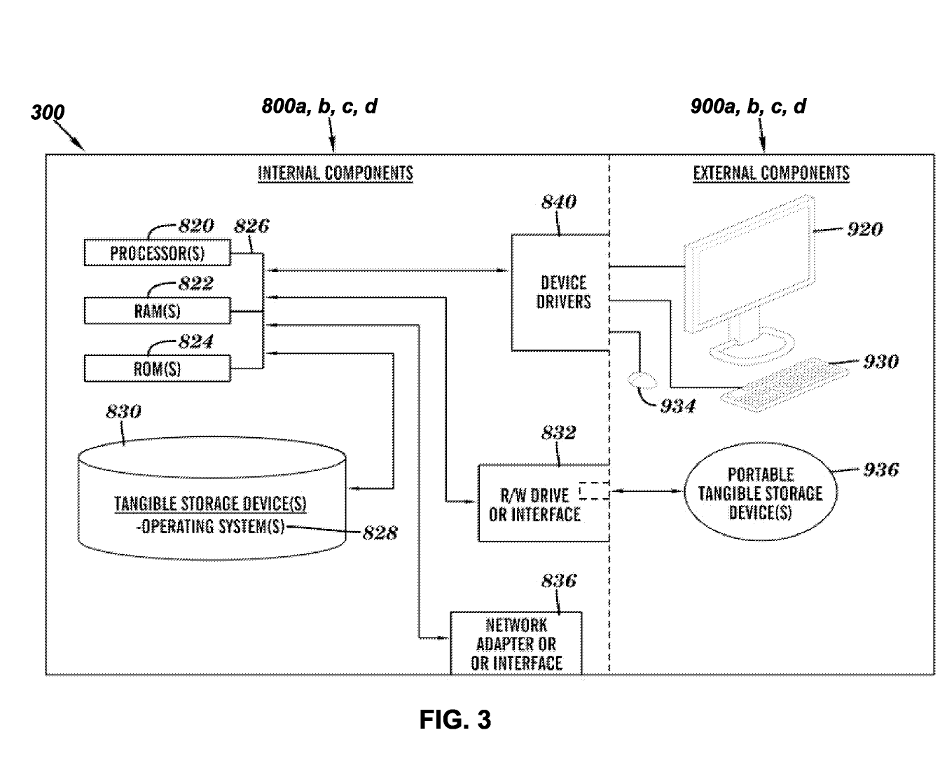

The client computers 102a-c may communicate with server computer 112 via the communications network 110. The communications network 110 may include connections, such as wire, wireless communication links, or fiber optic cables. Additionally, the communications network 110 may include a plurality of routers 114a and 114b that route network data to computers 102a-c and servers 112. As will be discussed with reference to FIG. 3, server computer 112 may include internal components 800a and external components 900a, respectively and client computers 102a-c may include internal components 800b, c, d and external components 900b, c, d, respectively. Client computers 102a-c may be, for example, a mobile device, a telephone, a PDA, a netbook, a laptop computer, a tablet computer, a desktop computer, or any type of computing device capable of running a program and accessing a network.

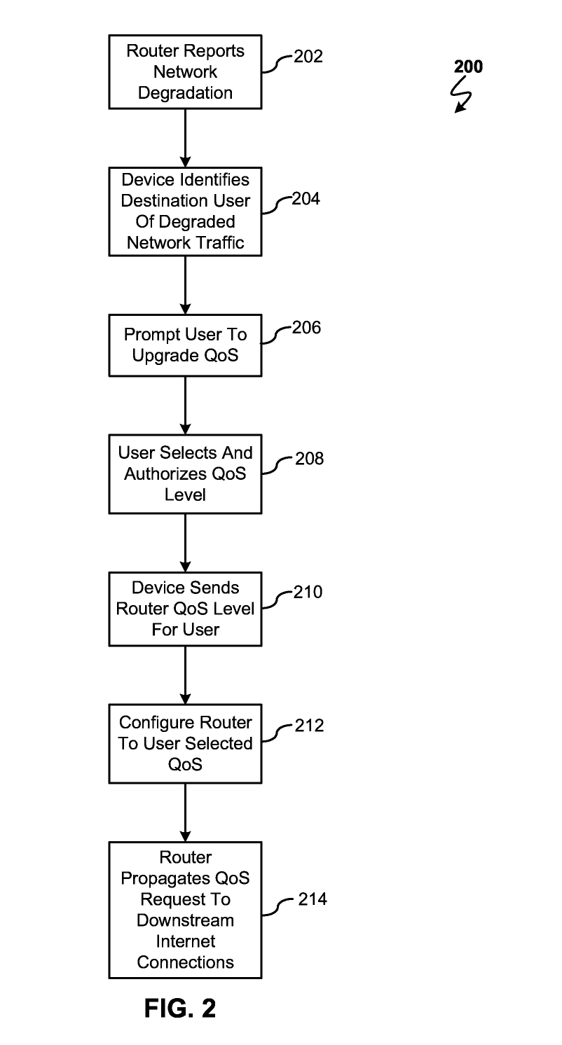

A program, such as a cooperatively managed QoS program 108a and 108b may run on client computers 102a-c or on the server computer 112. The cooperatively managed QoS program 108a and 108b may be used to cooperatively establish quality of service levels for users connected to routers via an active communications channel. The cooperatively managed QoS program 108a and 108b is explained in further detail below with respect to FIG. 2.

Referring now to FIG. 2, an operational flow chart illustrating the exemplary process 200 by the cooperatively managed quality of service (QoS) program 108a and 108b (FIG. 1) according to at least one embodiment is depicted.

At 202, a network router 114a and 114b (FIG. 1) may report degradation associated with an active communications channel that is occurring, or that may occur in the near future, by sending an indication of network degradation to the process 200. As such, the active communications channel may correspond with an end-to-end connection (e.g., network connection) from one electronic device (e.g., router 114a and 114b: FIG. 1) to another electronic device (e.g., client computer 102a-c: FIG. 1). For example, a router 114a and 114b (FIG. 1) may report network degradation in response to detecting network congestion at the router 114a and 114b (FIG. 1). Also, a router 114a and 114b (FIG. 1) may detect network congestion when incoming network data packet traffic (i.e., packet input) exceeds the router's 114a and 114b (FIG. 1) outgoing bandwidth (i.e., packet capacity).

According to at least one embodiment, the router 114a and 114b (FIG. 1) may respond to network congestion by discarding data packets, thereby degrading network traffic, since the output queues of the router may be full. According to at least one alternate embodiment, the router 114a and 114b (FIG. 1) may respond to network congestion by delaying the forwarding of a packet to the user's electronic device (i.e., user device). Once the router 114a and 114b (FIG. 1) has detected network degradation (i.e., a degradation event), the router 114a and 114b (FIG. 1) may report the network degradation to the electronic device (e.g., client computer 102a: FIG. 1) that may be the destination for the degraded network traffic. According to at least one alternate embodiment, the router 114a and 114b (FIG. 1) may detect that output queues in the router 114a and 114b (FIG. 1) are nearly full and therefore, send an indication of network degradation to the process 200 before anticipated network degradation may occur.

For example, a public network at an airport may have many users wirelessly connected to a router 114a and 114b (FIG. 1) that is experiencing network congestion. As such, one user may be watching streamed video content with a mobile device, such as a smartphone. The router 114a and 114b (FIG. 1) may handle the congested state by discarding packets associated with the streaming video content destined for the user's smartphone. In response to discarding the streaming video content data packets, the router 114a and 114b (FIG. 1) may send an indication of network degradation to the process 200 of the cooperatively managed QoS program 108a and 108b (FIG. 1) executing on the user's smartphone indicating that the network traffic to the user's smartphone is being degraded.

Next, at 204, the electronic device (e.g., client computer 102a: FIG. 1) connected to the router 114a and 114b (FIG. 1) may identify the user that may receive degraded network traffic. According to at least one embodiment, the process 200 may send a request to the electronic device's operating system to identify the user that is currently logged in to the electronic device that may be affected by degraded network traffic. The electronic device's operating system may send to the process 200 an identifier corresponding to the identified user (e.g., the user's username). In instances when the current user operating the electronic device cannot be identified based on which user is logged in, the process 200 may request that the user be prompted to log in to the operating system or an application for identification purposes. The process 200 may then collect identifying information associated with the user from the operating system or application that the user logged into to be identified.

Then, at 206, the process 200 may prompt the user to upgrade the QoS for the user's network traffic. According to at least one embodiment, the process 200 may request that a prompt be displayed to the user that indicates to the user that the user's network traffic has been degraded or may soon be degraded. The user prompt may also include information regarding what network traffic may be affected (e.g., streaming video content). The process 200 may, for example, send a request to the operating system or to an application installed on the user's electronic device to display a user prompt. The user prompt may also be generated in other ways. Additionally, the user prompt may also ask the user if the user would like to upgrade the QoS level. If the user does not respond, or declines to upgrade the QoS, the router may continue to degrade the network traffic to the user's electronic device. After prompting the user, the process 200 may collect any user response to the prompt (e.g., user selected QoS level) or record that no response was given by the user.

The prompt to the user may further include information such as the available levels of QoS and the quality that may be perceived by the user. For example, the prompt may give the user a choice of QoS levels to select from a list of available QoS levels and provide example bit rates for video streaming quality that may be sustained at each listed QoS level. The prompt may circumstantially alter the provided examples of perceived quality based on types of packets (e.g., voice over internet protocol or streamed video content) that are being discarded or delayed. The packet type may be determined, for example, based on the port where the packets are being sent.

Additionally, according to at least one embodiment, the prompt to the user may ask for payment in exchange for upgraded QoS levels. For example, if a user selects an upgraded QoS level, the prompt may ask the user to enter payment information (e.g., credit card number, credit card expiration date, name of cardholder, etc.) to pay for the desired QoS level.

According to at least one alternate embodiment, upgraded QoS level options may be restricted based on user roles. For example, in a company, only certain designated employee roles (e.g., managers) may be prompted with options to upgrade the QoS level. For a router 114a and 114b (FIG. 1) used by a family, upgraded QoS levels may be restricted only to persons with the family role of a parent and not children.

Furthermore, according to at least one embodiment, upgraded QoS levels may be time-limited. The user prompt may display information indicating the time-limit for the upgraded QoS level offered to the user. For example, the QoS level increase may be limited to five hours and the user prompt may indicate to the user that the time-limit is five hours. Thereafter, the user may be prompted to pay again or otherwise re-authenticate that the user may be entitled to the upgraded QoS after the previous time-limit (e.g., five hours) has expired.

Next, at 208, the user may select and authorize a QoS level. The user may select a QoS level from the choices provided by the user prompt previously generated at 206. Additionally, the user may authorize the selected QoS level, for example, by entering credit card information in response to a user prompt that requires payment to authorize heightened QoS levels. Once the user has selected a quality of service level and provided the required authentication (e.g., by payment or user role), the process 200 may proceed to reconfigure the electronic devices (e.g., routers 114a and 114b: FIG. 1) that maintain the QoS level associated the active communications channel utilized be the user.

At 210, the electronic device (e.g., client computer 102a: FIG. 1) operated by the user may send information to the router to configure the QoS level for active communications channel associated with the user. According to at least one embodiment, the electronic device may send QoS information to the router 114a and 114b (FIG. 1) such as user identifier, the QoS level and the length of time (i.e., time-limit) that the router 114a and 114b (FIG. 1) may be required to provide for the user's network traffic passing through the router 114a and 114b (FIG. 1). The electronic device operated by the user may send QoS information to the router 114a and 114b (FIG. 1) in response to information collected from the user at 208.

Then, at 212, the router 114a and 114b (FIG. 1) may be configured to provide the user selected QoS level based on QoS information received. According to at least one embodiment, the router 114a and 114b (FIG. 1) may be sent QoS information for storage in a data repository, such as a database. Additionally, the router 114a and 114b (FIG. 1) may store a device identifier (e.g., media access control address) associated with the user's electronic device (e.g., client computer 102a: FIG. 1) in the data repository. The data repository may include read only memory or flash memory located inside the router 114a and 114b (FIG. 1). The router 114a and 114b (FIG. 1) may use the QoS information stored in the data repository to configure the router to prioritize network traffic destined for the user's electronic device passing through the active communications channel to match the QoS level selected by the user at 208.

For example, when router 114a and 114b (FIG. 1) packet queues reach maximum capacity, the router 114a and 114b (FIG. 1) may read from the data repository to check if any of the packets in the router's 114a and 114b (FIG. 1) queues that are next to be discarded or delayed are destined for a user with upgraded QoS levels. When packets destined for a user with upgraded QoS levels are next to be discarded or delayed, the router 114a and 114b (FIG. 1) may instead choose other packets in the queue that are not destined for a user with upgraded QoS level to be discarded or delayed in order to meet the QoS levels specified in the router's 114a and 114b (FIG. 1) data repository.

According to at least one other embodiment, information corresponding to the user (e.g., user identifier), the user selected QoS level, and device identifier information may be stored in an external data repository that may accessed by the router 114a and 114b (FIG. 1). The external data repository may be, for example, a database stored on a hard disk drive located within a server that is accessible by the router 114a and 114b (FIG. 1).

Next, at 214, the router (e.g., 114a: FIG. 1) may propagate the QoS request, and associated QoS information, downstream to other internet connections (e.g., router 114b: FIG. 1). Downstream internet connections (e.g., additional routers) that may impact the QoS level for the user may also be instructed to provide additional QoS for active communications channels that may transmit data to the user's electronic device. For example, the information relating to the user's QoS request (e.g., user identifier, QoS level, etc.) that the process 200 sent to the router (e.g., 114a: FIG. 1) at 210 may be sent to a downstream router (e.g., 114b: FIG. 1) associated with the active communications channel connected to the user's electronic device.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computers 102a-c (FIG. 1), and network server 112 (FIG. 1) may include respective sets of internal components 800 a, b, c, d and external components 900 a, b, c, d illustrated in FIG. 3. Each of the sets of internal components 800 a, b, c, d includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs such as a cooperatively managed QoS program 108a and 108b (FIG. 1), may be stored on one or more computer-readable tangible storage devices 830 for execution by one or more processors 820 via one or more RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, c, d also includes a R/W drive or interface 832 to read from and write to one or more portable computer-readable tangible storage devices 936 such as a CD-ROM, DVD, memory stick, magnetic tape, magnetic disk, optical disk or semiconductor storage device. The cooperatively managed QoS program 108a and 108b (FIG. 1) can be stored on one or more of the respective portable computer-readable tangible storage devices 936, read via the respective R/W drive or interface 832 and loaded into the respective hard drive 830.

Each set of internal components 800 a, b, c, d may also include network adapters (or switch port cards) or interfaces 836 such as a TCP/IP adapter cards, wireless wi-fi interface cards, or 3G or 4G wireless interface cards or other wired or wireless communication links. The cooperatively managed QoS program 108a (FIG. 1) in client computer 102a (FIG. 1) and the cooperatively managed QoS program 108b (FIG. 1) in network server computer 112 (FIG. 1) can be downloaded from an external computer (e.g., server) via a network (for example, the Internet, a local area network or other, wide area network) and respective network adapters or interfaces 836. From the network adapters (or switch port adaptors) or interfaces 836, the cooperatively managed QoS program 108a (FIG. 1) in client computer 102a (FIG. 1) and the cooperatively managed QoS program 108b (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b, c, d can include a computer display monitor 920, a keyboard 930, and a computer mouse 934. External components 900 a, b, c, d can also include touch screens, virtual keyboards, touch pads, pointing devices, and other human interface devices. Each of the sets of internal components 800 a, b, c, d also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing a quality of service level within a plurality of quality of service levels associated with an active communications channel, the method comprising:
receiving an indication of network degradation corresponding with a degradation event from a router, wherein the degradation event is associated with the active communications channel;
requesting an identifier corresponding with a user operating a user device, wherein the user device is associated with the active communications channel;
prompting the user operating the user device to select the quality of service level within the plurality of quality of service levels associated with the active communications channel;
receiving a user selected quality of service level and the identifier corresponding with the user, wherein the user selected quality of service level is associated with the identifier corresponding with the user; and
configuring the quality of service level associated with the active communications channel to match the user selected quality of service level.

2. The method of claim 1, wherein configuring the quality of service level associated with the active communications channel comprises sending the user selected quality of service level and associated identifier corresponding with the user to the router.

3. The method of claim 1, wherein prompting the user comprises collecting a plurality of payment information from the user in exchange for configuring the quality of service level associated with the active communications channel.

4. The method of claim 1, wherein prompting the user comprises providing the user with options to configure the quality of service level based on a user role associated with the user.

5. The method of claim 1, further comprising:
storing the user selected quality of service level and identifier corresponding with the user in a data repository, wherein the data repository is accessible by the router; and
sending the user selected quality of service level to a plurality of downstream internet connections.

6. The method of claim 5, wherein storing the user selected quality of service level and identifier corresponding with the user further comprises storing a device identifier corresponding with the user device.

7. The method of claim 1, wherein the active communications channel comprises an end-to-end connection from a first electronic device to second electronic device.

8. A computer system for managing a quality of service level within a plurality of quality of service levels associated with an active communications channel, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an indication of network degradation corresponding with a degradation event from a router, wherein the degradation event is associated with the active communications channel;
requesting an identifier corresponding with a user operating a user device, wherein the user device is associated with the active communications channel;
prompting the user operating the user device to select the quality of service level within the plurality of quality of service levels associated with the active communications channel;
receiving a user selected quality of service level and the identifier corresponding with the user, wherein the user selected quality of service level is associated with the identifier corresponding with the user; and
configuring the quality of service level associated with the active communications channel to match the user selected quality of service level.

9. The computer system of claim 8, wherein configuring the quality of service level associated with the active communications channel comprises sending the user selected quality of service level and associated identifier corresponding with the user to the router.

10. The computer system of claim 8, wherein prompting the user comprises collecting a plurality of payment information from the user in exchange for configuring the quality of service level associated with the active communications channel.

11. The computer system of claim 8, wherein prompting the user comprises providing the user with options to configure the quality of service level based on a user role associated with the user.

12. The computer system of claim 8, further comprising:
storing the user selected quality of service level and identifier corresponding with the user in a data repository, wherein the data repository is accessible by the router; and
sending the user selected quality of service level to a plurality of downstream internet connections.

13. The computer system of claim 12, wherein storing the user selected quality of service level and identifier corresponding with the user further comprises storing a device identifier corresponding with the user device.

14. The computer system of claim 8, wherein the active communications channel comprises an end-to-end connection from a first electronic device to a second electronic device.

15. A computer program product for managing a quality of service level within a plurality of quality of service levels associated with an active communications channel, comprising:
one or more computer-readable storage medium and program instructions stored on at least one of the one or more tangible storage medium, the program instructions executable by a processor, the program instructions comprising:
program instructions to receive an indication of network degradation corresponding with a degradation event from a router, wherein the degradation event is associated with the active communications channel;
program instructions to request an identifier corresponding with a user operating a user device, wherein the user device is associated with the active communications channel;
program instructions to prompt the user operating the user device to select the quality of service level within the plurality of quality of service levels associated with the active communications channel;
program instructions to receive a user selected quality of service level and the identifier corresponding with the user, wherein the user selected quality of service level is associated with the identifier corresponding with the user; and
program instructions to configure the quality of service level associated with the active communications channel to match the user selected quality of service level.

16. The computer program product of claim 15, wherein program instructions to configure the quality of service level associated with the active communications channel comprises sending the user selected quality of service level and associated identifier corresponding with the user to the router.

17. The computer program product of claim 15, wherein program instructions to prompt the user comprises collecting a plurality of payment information from the user in exchange for configuring the quality of service level associated with the active communications channel.

18. The computer program product of claim 15, wherein program instructions to prompt the user comprises providing the user with options to configure the quality of service level based on a user role associated with the user.

19. The computer program product of claim 15, further comprising:
program instructions to store the user selected quality of service level and identifier corresponding with the user in a data repository, wherein the data repository is accessible by the router; and
program instructions to send the user selected quality of service level to a plurality of downstream internet connections.

20. The computer program product of claim 19, wherein program instructions to store the user selected quality of service level and identifier corresponding with the user further comprises storing a device identifier corresponding with the user device.
